(19) United States
(12) Patent Application Publication
(10) Pub. No.: US 2015/0121540 A1
(43) Pub. Date: Apr. 30, 2015

(54) Software and Inventory Licensing System and Method

(71) Applicant: Linear LLC, Carlsbad, CA (US)

(72) Inventors: Steven Douglas Citron, Oceanside, CA (US); David Charles Guthrie, Chester Springs, PA (US); Ik Huh, Seoul (KR); John Raymond Lafond, Norfolk, MA (US); Kevin Dean Ward, Bitely, MI (US)

(73) Assignee: Linear LLC, Carlsbad, CA (US)

(21) Appl. No.: 14/064,426

(22) Filed: Oct. 28, 2013

(51) Int. Cl. G06F 21/10; G06Q 50/18; G06F 9/445

(52) U.S. Cl. CPC G06F 21/10; G06F 8/65; G06Q 50/184
USPC 726/27

(57) ABSTRACT

A system for distributing a license key for upgrading an access control system. A portable token that includes first and second identifiers, such as a visible serial number and a concealed control number that can be derived from the serial number. The access control system is identified by a third identifier, such as a MAC address. A license server generates a license key from the first, second and third identifiers that is operative to allow access to software features that are resident on the access control system without the need for an Internet connection.

### FIELD OF THE INVENTION

The present invention relates to upgrade and configuration of software resident in a control system.

### BACKGROUND OF THE INVENTION

Products or families of products from a common source may have very similar methods or principles of operation. Such products may be a combination of hardware and software, with both the hardware and software sharing similar attributes and methods of operation. For example, in an access control system that controls and operates a number of doors or other barriers, the software for operating a one door control system may be similar to the software for operating a greater number of doors. Moreover, the hardware and housing for a one door control system may be similar or identical to the hardware and housing for operating a greater number of doors.

Where such similarity exists between both the hardware and software comprising different product models, it would be desirable for a user or purchaser of one product model to easily upgrade to a different or more advanced product model. Software upgrades or updates are now commonly accomplished via download of updated software over a computer network such as the Internet. However, because of factors such as the need for high security, remote location or new construction where Internet connectivity has not yet been established, products such as access or barrier control systems are often located in locations without an Internet connection. Acquiring a software upgrade in such circumstances may be difficult or impossible. Moreover, even in a product line that involves various product models having similar hardware and software, a user or purchaser that wishes to upgrade from one product model to another product model is typically required to purchase the new product model hardware. In many instances, this is due to higher processing and/or memory required for more advanced systems.

In addition, the rise of software upgrades via the Internet also effectively bypasses third party distribution entities by establishing a direct connection between the end-user or installing dealer and the supplier of the software. Often, the entire software package may be downloaded via the Internet without the need for any physical media. Thus, there is often no opportunity for a third party distribution entity to share or participate in the selling or updating of the software.

### SUMMARY OF THE INVENTION

The present invention addresses these issues and provides a novel system and method for upgrading a system to another system in a family of systems without the need to re-purchase new hardware and software, and without the need for an Internet connection to upgrade the system. In one embodiment, a system and method is provided by which a software upgrade license key is distributed via a portable token and may be used to upgrade a control system without the need for an Internet connection or software download. In another embodiment, a method is provided by which a software license key is distributed at the point of sale through a token and a license server that allows generic hardware to be configured into a specific control system without the need for an Internet connection or software download.

The present invention provides unprecedented system scaleability and upgradability. When applied to an access control system, the invention provides the ability to scale the most basic, entry level, one door control system, by incremental use of license keys, to an advanced, full-featured, 360-door (or more) control system. By using a generic hardware platform and common code base software across an entire product family, manufacturing and sales forecasting processes are dramatically simplified in comparison to manufacturers that use different hardware and software for each product model/configuration. The number of physical, packaged products that must be kept on distribution shelves is reduced, thereby lowering the cost of field inventory, and the physical products that are present in inventory and in the field can be expanded without software download or an Internet connection.

One embodiment of the invention is a method for expanding or upgrading a control system. A portable token that contains at least two identifiers is provided. At least one of the identifiers is concealed from view in its packaging. A license key is generated from the token identifiers and a unique identifier of the control system that is being upgraded. Access to additional software features that are resident on the control system is allowed upon entry of the license key into the access control system.

The portable token may be a card that contains a serial number as one identifier and a control number as another identifier. The serial number may be visible through the packaging while the control number is concealed, such as by a tamper-revealing film that must be scratched off in order to reveal the control number. The control number may be derived from an algorithm that is indexed off of the serial number, in order to prevent fraud or unauthorized use. It may also simply be a random set of numbers that are associated or paired to the serial number in a cross-reference database. The unique identifier of the access control system may be a MAC address of the access control system or any other type of soft or hard coded serialization that is typically used in the trade.

The license key may be generated by accessing a license server via the Internet. The license key, once generated, may be entered directly into the control system without the need for an Internet connection in order to unlock additional software features that are resident but dormant in the control system. Where the control system is an access control system, the license key upgrades the access control system to a greater door capacity or adds other additional functionality or technology integrations such as video, visitor management, remote connectivity to a hosting server, burglar panel integration, time and attendance systems, or many of the other associated technologies that can be integrated into an access control system. The access control system is preferably a member of a family of access control system that have a common hardware and software platform.

Another embodiment of the invention is a token, such as a plastic card, for obtaining a license key to upgrade a control system. A first identifier, such as a serial number, is visible on the token, and a second identifier, such as a control number, is concealed by a temporary cover on the token. The serial number and the control number allow the license key to be obtained when provided to a third party in conjunction with an identifier, such as a MAC address, of the control system.

Another embodiment of the invention is a system for distributing a license key for upgrading an access control system. The system includes a portable token that includes first and second identifiers, an access control system that is identified by a third identifier, and a license server that generates the license key from the first, second and third identifiers. The license key is operative to allow access to software features that are resident on the access control system without the need for an Internet connection.

The first identifier may be a visible serial number, the second identifier may be a concealed control number that may or may not be derived from the serial number, and the third identifier may be a MAC address of the controller for an access control system. The license server can derive the control number from the serial number, or from a cross-reference table or database, in order to validate the card. The license key, once generated, may be entered directly into the access control system without need of an Internet connection.

Other features, elements, processes, steps, characteristics and advantages of the present invention will become more apparent from the following detailed description of the embodiments of the present invention with reference to the attached drawings.

### BRIEF DESCRIPTION OF THE DRAWINGS

FIG. 1A is a front view of an upgrade card according to one embodiment of the invention.

FIG. 1B is a rear view of the upgrade card of FIG. 1A.

FIG. 2A is a flowchart of a method for obtaining a license key.

FIG. 2B is a block diagram of a system implementing the method of FIG. 2A.

FIG. 3A is a sample display screen for an existing member sign-in.

FIG. 3B is a sample display screen for registering a new member.

FIG. 3C is a sample display screen for proceeding with creating a license key without registering or creating an account on the license server.

FIG. 4 is a sample display screen showing the systems of a registered user.

FIG. 5 is a sample display screen for registering a new user.

FIG. 6 is a sample display screen for entering a MAC address.

FIG. 7 is a sample display screen for entering an upgrade card serial number.

FIG. 8 is a sample display screen for entering an upgrade card control number.

FIG. 9 is a sample display screen for granting a license and displaying the license key.

FIG. 10 is a diagram showing exemplary system configurations available from generic hardware and an upgrade card.

### DETAILED DESCRIPTION OF THE INVENTION

The present invention provides a system and method by which a software upgrade license key is distributed through the sale of a portable token, such as a plastic card, that contains two token identifiers, such as two sets of alpha/numeric characters. The token may be any of a variety of physical mediums, such as a plastic card, thumb drive, CD, etc., and the token identifiers are typically two sets of alpha/numeric characters, but could take other forms. The following description is primarily of an embodiment in which the token takes the form of an upgrade card, and the token identifiers take the form of a serial number and a control number. Thus, the terminology of an upgrade card and serial and control numbers will primarily be used rather than tokens and token identifiers. However, it should be understood that this is merely one example, and that the token and token identifiers could take other forms.

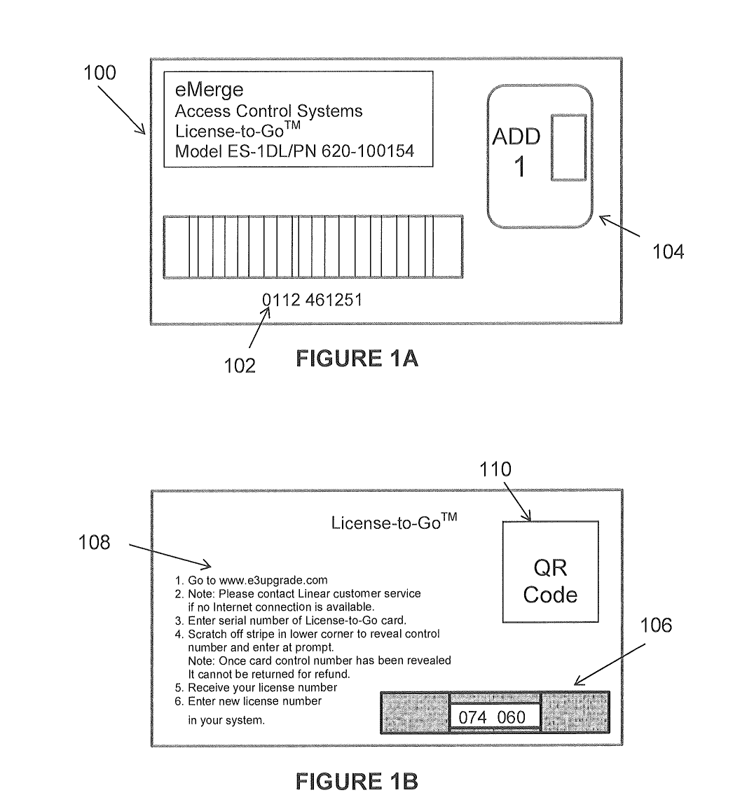

FIGS. 1A and 1B illustrate one implementation of a token according to the present invention, in the form of a plastic upgrade card 100. In one implementation, the card is used in conjunction with applicant's e3 eMerge family of access control systems and is known as a “License-to-Go”™ (LTG) card. Typically, card 100 will be distributed and sold in the same retail location that the system to be upgraded, such as an access control system, is sold. As shown in FIG. 1A, which is a front view of card 100, serial number 102 is visible on the front of card 100. A portion of serial number 102 may contain some alpha/numeric characters that indicate what type of upgrade card it is, allowing for easy identification in the field. In the e3 eMerge family of access control systems, the LTG card is “live” on the store shelf and is pre-established by its serial number for a specific enhancement or configuration. This is in contrast to a Configure-to-Go™ (CTG) card, to be described later, which is generic and configurable on the fly at the register. The front of card 100 may also include a graphical icon 104 or other indicator indicating what type of license the card 100 conveys. For instance, icon 104 may indicate that card 100 conveys a license to add one door to an access control system.

As shown in FIG. 1B, which is a rear view of card 100, control number 106 is covered by a tamper-revealing film that must be scratched off in order to reveal control number 106. FIG. 1B shows the tamper-revealing film scratched off to the extent to reveal control number 106. As will be explained in more detail, in order to deter against unauthorized duplication or fraudulent activities, control number 106 may be derived from an algorithm that is indexed off serial number 102. Where serial number 102 includes a portion indicating the type of upgrade card, this adds another variable to the algorithm for deriving control number 106 that makes reverse engineering even more difficult. In addition to control number 106, the rear of card 100 may include instructions 108 for use of card 100, and a QR code 110 or other identifier for quick access to the license server for entry of the serial and control numbers provided on card 100.

In one embodiment, serial number 102 is displayed or visible through the retail packaging of card 100, while control number 106 is concealed as described above. For instance, card 100 may be packaged in tamper revealing packaging that displays serial number 102 on the front of the packaging, whereas control number 106 is concealed on the rear of the card beneath a removable scratch-off coating. Displaying serial number 102 advantageously facilitates in store inventory tracking and can potentially be used for activating the card at the point of sale, while concealing control number 106 prohibits in-store viewing of control number 106 and makes card tampering easily identifiable.

The depiction in FIGS. 1A and 1B is just one possible configuration of control card 100. Many other configurations are possible. For instance, icon 104, instructions 108, and QR code 110 may be positioned in different locations on the front or the back of card 100, or may be omitted completely. Control number 106 could be moved to the front of card 100, so long as it is concealed. The key aspects of card 100 are that at least one of the two identifiers 102 and 106 is concealed and not visible until removed from its packaging, such that someone cannot discover both identifiers and obtain an unauthorized license key without purchasing the upgrade card. Moreover, as noted above, the token containing the two identifiers is not necessarily a card, and could be another portable medium such as a thumb drive, CD, etc.

The use of two identifiers configured as described above provides a high level of security against reverse engineering that would allow users to gain access to additional system features and capabilities without paying the appropriate licensing fee. This is accomplished by relating the two token identifiers such that the license server can confirm that they are a valid combination. In one implementation, as noted above, the control number is derived by an algorithm from the serial number. The licensing server may apply the algorithm to the serial number entered by the user to derive a control number, and then confirm that the derived control number matches the control number entered by the user. The server may contain a cross-reference table for all serial numbers along with control numbers that have been pre-derived from the serial numbers by applying the algorithm. The algorithm may be changed periodically to prevent reverse engineering of the control numbers that are linked to the serial numbers. Alternatively, rather than being derived from an algorithm, the control number may simply be a random set of characters that is associated in the cross-reference table with a particular serial number.

Serial number 102 and control number 106 obtained from upgrade card 100 are entered along with a unique and valid identifier of the system to be upgraded, such as a media access control (MAC) address, into a license server. The license server then generates and returns a software upgrade license key. Thus, the license server requires three identifiers: (1) the MAC address of the system being updated; (2) the serial number of the upgrade card; and (3) the control number of the upgrade card. Once these numbers have been entered into the server and validated, the server can provide a custom license key that only works with the specific system having the matching MAC address that was entered into the server in order to obtain the key, or can issue a generic license key that can be used to upgrade or activate additional functionality, the previous being more secure. While this description describes the system identifier as a MAC address, as with the token identifiers, this is merely one example, and the system identifier may take other forms, such as some other set of alpha/numeric characters that uniquely identifies the particular system to be upgraded.

When a software upgrade license key has been obtained by entering the system MAC address and the serial and control numbers from the upgrade card into a license server, the software upgrade license key is then entered into software that is resident on the equipment to be upgraded, and additional functionality in the software is “unlocked”. In other words, the end-user and/or installing dealer is permitted access to additional features that are resident but dormant in the software. Thus, in contrast to typical methods of software upgrade by Internet, no transfer or installation of new software is involved. Rather, the software is already resident in the system controller and simply needs to be unlocked. Whereas standard industry practices are known for updating a common software code base, such as through the Internet via an update server, the present invention relates to unlocking various features within such a common software code base without the need for Internet connectivity.

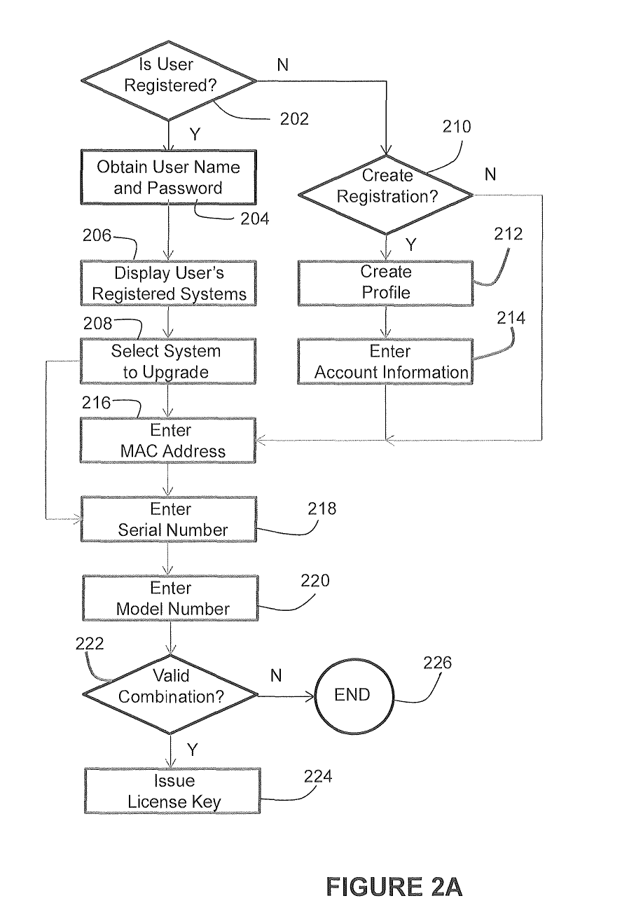

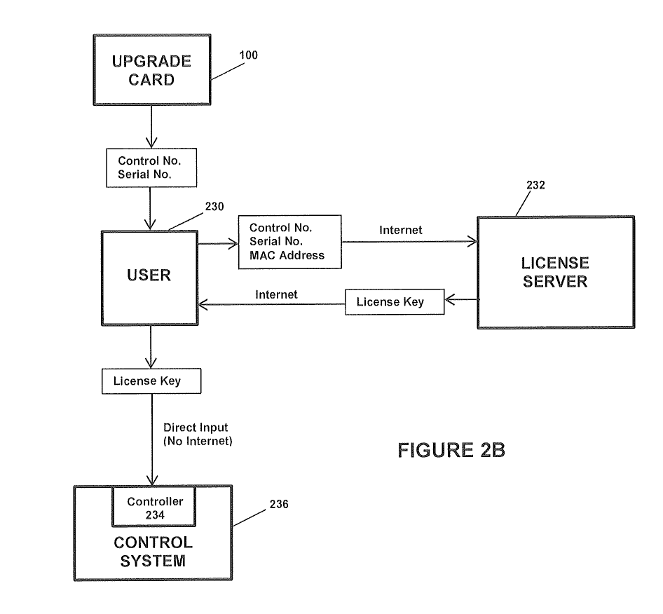

FIG. 2A is a flowchart of a method 200 for obtaining a license key using an upgrade card 100 and a valid system MAC address. Using an Internet connection, the user navigates to the website of the license server. As shown in FIG. 2B, which is a block diagram of a system implementing the method of FIG. 2A, a user 230 of upgrade card 100 accesses license server 232 via the Internet. This information may be provided on card 100 in the form of the website address or a QR code 110 for quickly accessing the website on license server 232. In the event that no Internet connection is available, the user or installer may alternatively contact the manufacturer by other means such as telephone or facsimile and obtain the license key by providing the manufacturer with the serial and control numbers from card 100 and the MAC address. The manufacturer can then validate this information and provide the user or installer with the appropriate license key.

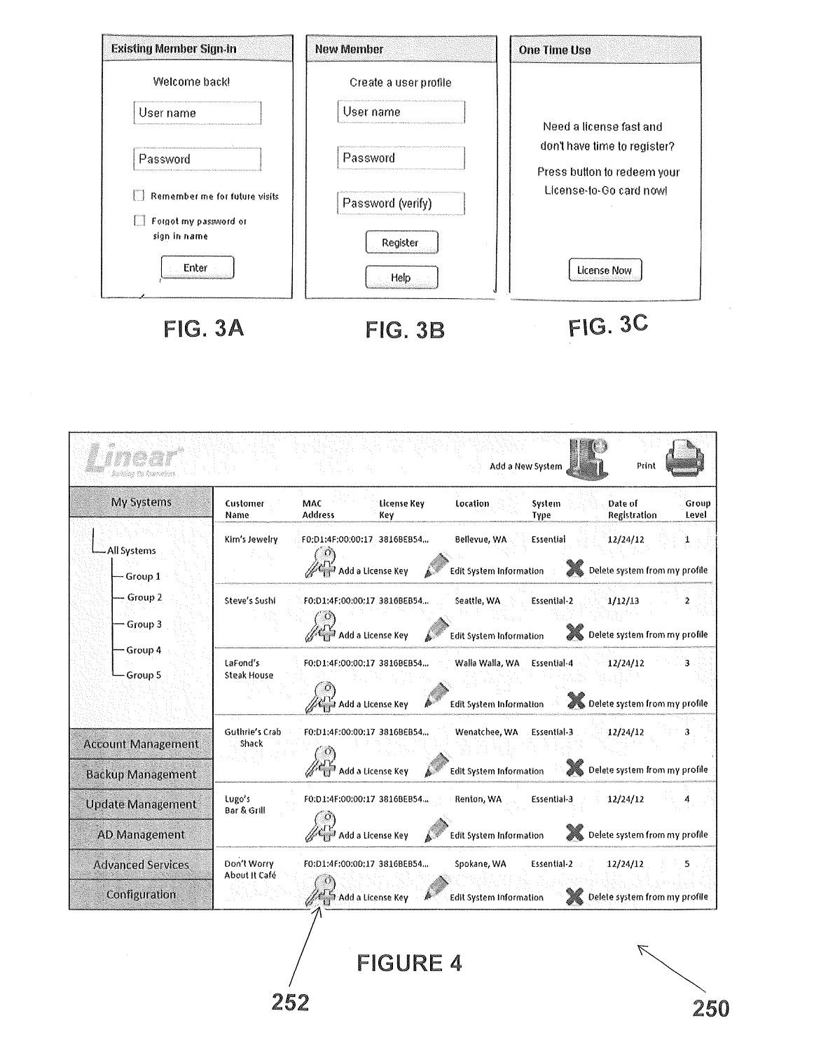

Upon successfully navigating to the website of license server 232, the user may be presented with different options for proceeding. In one implementation, three options for proceeding are provided: as an existing, pre-registered member or user (FIG. 3A); by registering and creating a new account (FIG. 3B); or by not registering and proceeding with a one-time use (FIG. 3C). If the user is already registered (step 202-Y), then the user is prompted on a display such as that shown in FIG. 3A to enter a user name and password. Upon entering a valid user name and password (step 204), the user is then taken to their custom webpage that will display information about all of the systems that user has registered and upgraded (step 206). Advantageously, a user does not have to re-enter MAC addresses for systems they have previously registered.

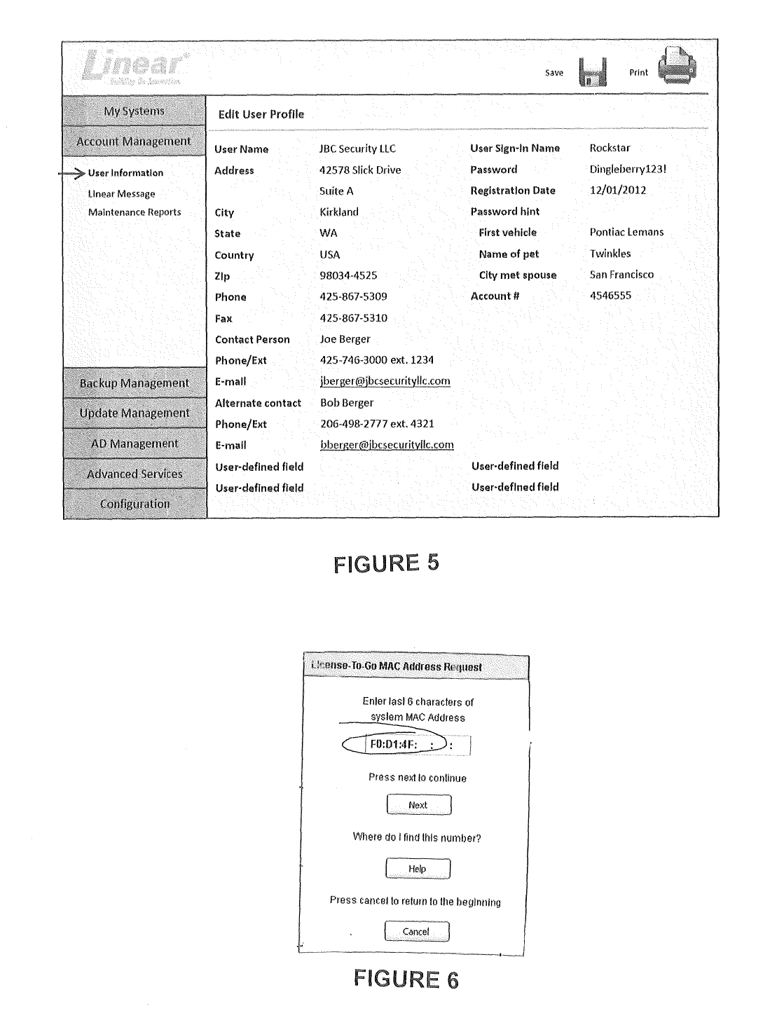

In step 204, user name and password recovery procedures may be provided in case the user forgets the user name and/or password. For instance, the user may be prompted to enter an email address associated with the account, to which an e-mail containing a link to reset the password is sent. Upon entering the correct user name and password, the user is taken to a custom webpage such as a “My Systems” page. An example of such a page 250 is shown in FIG. 4. Here, information about each of the user's systems that has been previously registered and/or upgraded is shown. Information such as the MAC address of the system, previously-used license keys, the location of the system, system type and date of registration may be shown. For each system, the user may be given options such as adding a license key, editing the system information, and deleting the system from their profile. The user may also be given the option to add a new system to their profile. A user may select to upgrade (add a license key to) a system by clicking on an appropriate icon or button 252 contained in the system information, or by otherwise identifying the particular system to be upgraded (step 208).

Where the user is not registered (step 202—N), the user may be offered the option to create a new account by a display such as that shown in FIG. 3B. If the user opts to create a new account (step 210—Y), they will be prompted to create a user name and password, and then routed to a more comprehensive registration page such as registration page 260 shown in FIG. 5. Here, the user enters various items of contact information that will be associated with their account, and the MAC addresses of the equipment they register will be associated to this account (to be entered in a later step).

The registration process is advantageous in that it facilitates traceability of installing dealers and installation sites. Third party distributors such as dealers may also set up a profile and associate each system model and their respective MAC addresses that they have installed/upgraded with their profile. The dealer can thereby organize and track their installed systems, and since the dealer will already have the MAC address of each system in their profile, easier upgrading of those systems is facilitated.

If the user is not pre-registered and does not wish to register a new account (step 210—N), then a display such as that shown in FIG. 3C may be presented, providing the user with the option to obtain a license key quickly without requiring sign-in or registration.

In step 216, after a new user has registered (step 214), or after a user has opted to obtain a license key without sign-in or registration, the user is prompted to enter the MAC address of the system to be upgraded. In the case of a pre-registered user, the MAC address of the selected system is already stored in the user's profile and need not be re-entered. Thus, the user is not required to enter the MAC address and the process skips over step 216 and proceeds directly to entry of the serial number in step 218. FIG. 6 depicts an exemplary display for prompting a user to enter the MAC address. The initial digits of the MAC address may be pre-populated, such that the user is only required to enter the last digits of the MAC address. In the example shown in FIG. 6, the first six digits of the MAC address are pre-populated, and the user must enter the last six digits. A link or information may also be provided to assist the user in finding the MAC address of the system. If the MAC address entered by the user is invalid, they may be given a predetermined number of additional attempts to enter a valid MAC address before denying further access to the site for a predetermined amount of time.

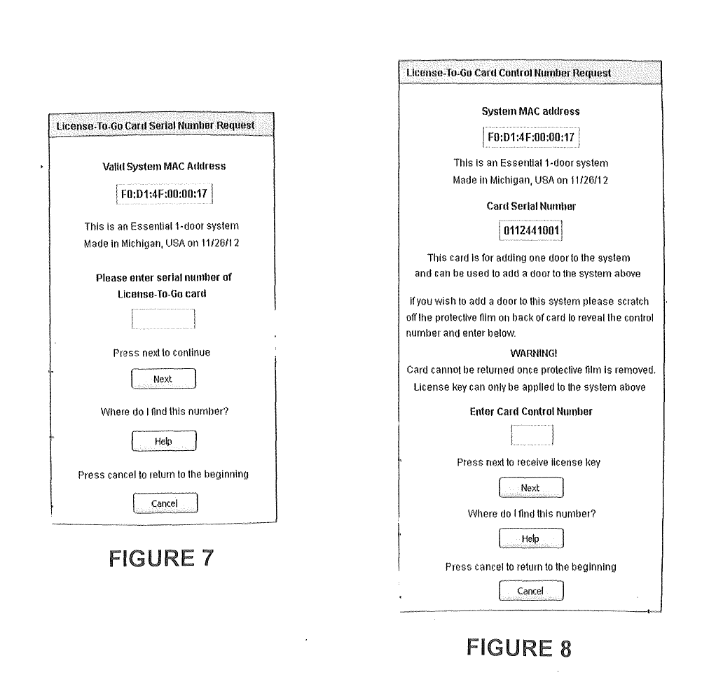

Once a valid MAC address has been entered in step 216, information about the system derived from the MAC address may be displayed (“This is an Essential 1-door system made in Michigan, USA on Nov. 26, 2012”), and the user is then prompted in step 218 to enter the serial number from upgrade card 100 (FIG. 7). Information may be provided at this stage as to how to find the serial number, and a limited number of additional attempts may be allowed if an invalid serial number is entered before denying further access to the site for a predetermined amount of time.

Once a valid serial number has been obtained, as shown in FIG. 8, information about the license key associated with that serial number may be displayed (“This card is for adding one door to the system and can be used to add a door to the system above”), and the user is prompted to enter the control number (step 220) if such an upgrade is permissible. License server 232 provides a level of configuration control such that invalid sets of features or upgrades cannot be executed. For example, in the family of e3 eMerge access control models provided by Linear, the entry level Essential system can only accommodate up to four doors of access control before being upgraded to the Elite 36 door model. In this instance, an Essential cannot be upgraded to five doors but must instead be upgraded to the next model in the series. As described above, the control number is concealed and the user may be required, for example, to scratch off a protective film in order to reveal the control number. Appropriate warnings may be displayed, such that the user will not be able to return the card once the protective film is scratched off. A limited number of additional attempts may be allowed if an invalid control number is entered.

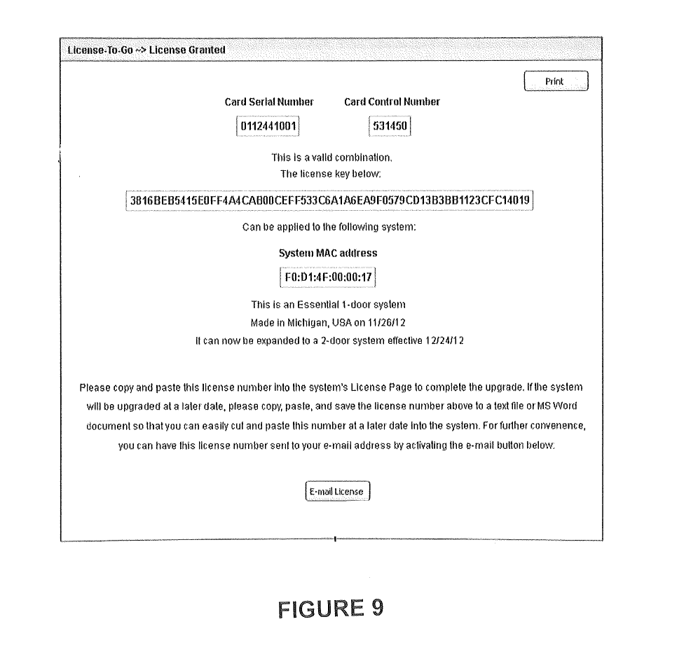

In step 222, license server 232 determines whether the card serial number and control number entered by the user are a valid combination. As described above, this may be accomplished by applying an algorithm to the serial number and confirming that the result matches the control number entered by the user, or by checking a cross-reference table of serial numbers and their matching control numbers. If the serial and control numbers are a valid combination, and the MAC address is a valid MAC address of a system eligible for the upgrade, license server 232 grants the license and displays the license key to user 230 (step 224). FIG. 9 shows a sample display where the entered serial and control numbers are a valid combination, and the license key is displayed. The user is prompted to provide an email address such that the license key may be emailed to the user's email account. Alternatively, or in addition, the user may write the license number down or cut and paste it into a text document. If the user is accessing the license server from a computer that also has access to the system to be upgraded, the user may cut and paste the license key directly into the license page of the system controller.

Though, as described above, the license key is typically acquired from a license server via the Internet, once a valid license key is acquired, no Internet connection is required in order to enter the license key into the licensing page of the system controller and unlock the associated upgrade. See, for example, FIG. 2B, which shows that whereas user 230 acquires the license key from license server 232 via an internet connection, the license key is then entered directly into the licensing page of controller 234 of control system 236. Thus, the present invention facilitates the upgrade of systems that are located in remote or new construction locations where no Internet connection is available, or that are located in high security facilities where no Internet connection is allowed.

As described herein, the system to be upgraded may be a security management platform, such as an access control system, wherein the software to be upgraded is resident on the main controller of the system. The additional functionality that is dormant in the software and that may be unlocked or accessed by an appropriate license key may include, but is not limited to, activation of additional relays to add doors to an access control system; API integration with a burglar alarm system; video recording and event management capabilities; overall system upgrades to higher level models; visitor management capability; asset tracking and management features; and the ability to network with other associated equipment or modules to control additional access doors or elevators.

The invention is preferably implemented in a family of products, such as access control systems, that share a common hardware and software platform. One example of such a family of products is the e3 eMerge family of access control systems of applicant. In this example, the most basic system (the Essential) is for controlling one door (a “one-door” system). The basic one-door system contains the complete software and code not only for its own operation, but also the complete software code for the operation of different and more advanced systems within the family. That is, the software resident on the one-door system for controlling one door may also be capable of controlling two doors, three doors, four doors, thirty-six doors, sixty-four doors or any other number of doors. Moreover, the software resident on the one-door system may also have enhanced features and functionalities in addition to those used for the one-door system. By obtaining an appropriate license key, a user or purchaser of the most basic system can gain access to these additional door capacities, features and functionalities that are resident (but dormant) on the system software without incurring the expense of purchasing an entirely new system, as previously described.

In one embodiment, the common software code for the entire family of systems is resident in the main controller of each system model of the family, such that a purchaser of any system can upgrade that system to any other system in the family simply by purchasing the appropriate upgrade card or token for the applicable license key. Preferably, and as in the case of the Linear e3 eMerge product line, the hardware for the various systems in the family is generic, such that little or no additional hardware is required to upgrade a system to a more advanced system. For example, a one-door access control system may be upgraded to an access control system with as many as four doors with no additional hardware. All that is required is the appropriate license key to gain access to the software required to control the additional doors. Even to upgrade to more advanced models, for controlling a greater number of doors, little additional hardware is required. For instance, to upgrade to an access control system for a number of doors greater than four, the only additional hardware that may be required is additional door modules to handle the increased door capacity.

In the example of the e3 eMerge family of access control systems, a common software code for the entire family of systems is resident in the printed circuit board (PCB) assembly contained in each system enclosure. As noted above, the hardware for the various systems in the family is generic, such that a system can be upgraded by a license key without requiring new hardware. In the e3 eMerge family, for example, while there are a high number of different system configurations (in one implementation, 59 baseline configurations), there are only three types of system enclosures: a low cost plastic enclosure (enclosing a common PCB module); a mid-priced standard size steel enclosure (enclosing a common PCB module); and a higher priced extra-large steel enclosure (enclosing a common PCB module). The PCB, on which the software resides, is common to each of these enclosures. Because of this modularity in software and hardware, the resulting end-item combinations are equal to the amount of primary software configurations multiplied by the amount of enclosure variations. This excludes additional variants that provide for functional integration with other technologies or other ala carte functionality that can be licensed.

Modularity of software and hardware is advantageous to distributors and dealers, as well as the end user. Rather than forecasting and stocking multiple hardware/software combinations (i.e., in the example above, 59 baseline configurations), the distributor would only need to stock each of the three generic systems (i.e. the plastic enclosure, and the standard and extra-large steel enclosures) and the PCB module on which the software resides. Thus, in this example, the distributor would need only to stock four items rather than 59 items. Each of these generic enclosures may be activated by a properly-obtained license key as described above and/or below.

In one implementation, applicable to the generic hardware and software scenario, there are two types of cards for activating or upgrading a system. A first type of card, referred to as mentioned above as a “License-to-Go™” (LTG) card, is essentially as described above. It is intended to be purchased by an installing dealer and used by same to upgrade a system in the field. The LTG card is pre-purchased by the distributor or reseller and is “live” on the store shelf. Thus, the LTG card is pre-activated, and once purchased from the reseller or distributor, can be immediately used by the installing dealer. A LTG card is pre-established by its serial number for a single specific enhancement or integration.

Alternatively, the LTG card may be activated at the register, in a similar fashion to a gift card, such that a distributor/reseller can openly display multiple LTG cards on their shelves, but the LTG cards are not activated (and the distributor/reseller is not billed) until activated at the register via the license server. This alternative configuration is a hybrid combining the single integration or feature enhancement of the LTG card, as described above, with activation at the register and subsequent invoicing of the sold feature to the distributor at the point of sale, which is more typical of the CTG card as described below. This alternative configuration is advantageous in that the LTG card is not live on the shelf and cannot be stolen in a usable form.

A second type of card, known as a “Configure-to-Go™” (CTG) card, looks physically different (in order to be distinguishable from) than the LTG card and is used to activate a system during the initial purchase of the system. The CTG card may be pre-paid and “live” on the store shelf, as in the case of the LTG card, or may not be pre-paid and not usable until activated at the store register. Where the CTG card is pre-paid, the distributor or reseller pays up front for a specific configuration which then can be applied to any base model. In this scenario, the distributor will stock a different CTG card for each primary system configuration. The CTG card is generic and configurable at the register and can include not only a key for a primary configuration, but that same license key can also include other enhancements and integrations. In other words, one CTG card can configure multiple combinations of features and integrations, as well as the primary base model configuration.

Where the CTG card is not pre-paid and must be activated at the register, even greater stock and working capital reductions and efficiencies can be achieved by the distributor or reseller since the card itself may also be made generic, with the specific configuration to be provided by the card not being fixed until activation at the register. Thus, one single card can be used for a variety of combined licenses, and a clerk can take a generic license card and activate a generic piece of hardware to any configuration at the point of sale. As the CTG card is not billed to the reseller/distributor until the time of activation, the reseller/distributor need only pay for and stock the generic hardware, and is not charged for software license activations until a final system sale or installation is made. Thus, the reseller/distributor can advantageously sell any system model from their inventory without having to tie-up working capital in specific hardware/software configurations. This not only reduces inventory and associated working capital requirements, but also prevents stock-outs because the generic hardware that is inventoried has the flexibility to be configured into any model, with any available feature and integration enhancements, at the point of sale.

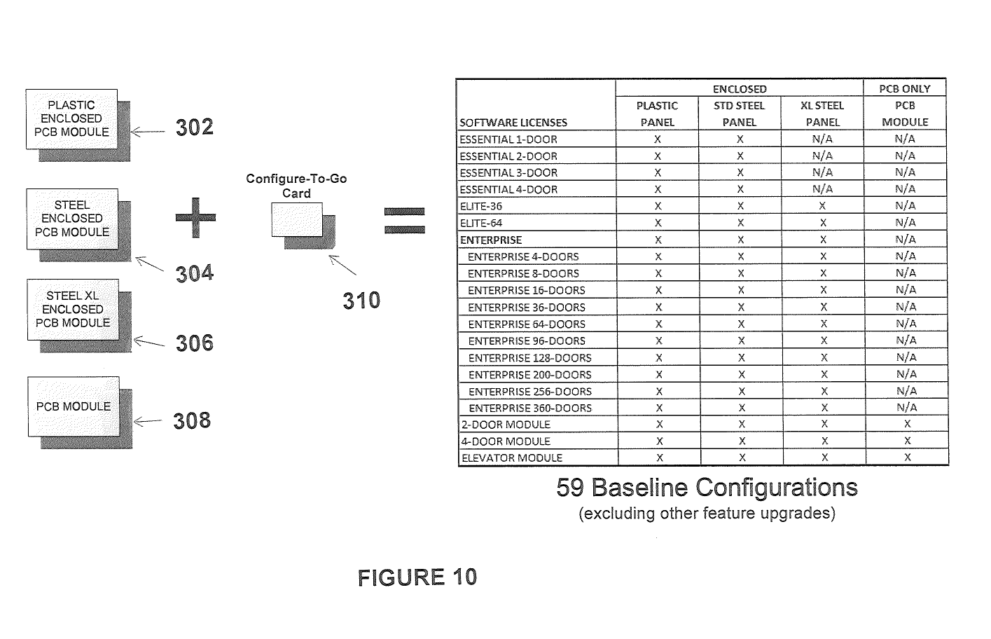

FIG. 10 is a diagram of one example of the configuration possibilities from a small amount of generic hardware and a CTG card. In FIG. 10, as described above, a distributor/reseller stocks just a plastic enclosed PCB module 302, a steel enclosed PCB module 304, a steel XL enclosed PCB module 306 and a stand-alone PCB module 308. In addition, the dealer/reseller utilizes a generic CTG card 310 that is not fixed to a specific configuration until activation at the register. From these five simple components, in the e3 eMerge system, 59 baseline configurations are possible, depending on the type of software license (rightmost column) and hardware that is chosen. This excludes all of the other variants possible, including incremental feature upgrades and technology integrations which, when considered in the equation of potential integrations, could result in hundreds or even thousands of potential unique end-items to meet customers' various needs and requirements.

As an example of a system sale and configuration, a customer seeking an “Elite-36” (36 door access control system—see FIG. 10) in a standard steel cabinet pulls the generic standard steel cabinet off the shelf along with a generic CTG card. At the register, the clerk enters the serial number from the CTG card into the manufacturer's license server and selects the desired type of software license(s), in this case, an Elite-36 license (and any other available and valid features and integrations). The serial number of the card is then registered as an Elite-36 license and Linear invoices the distributor/reseller accordingly at the time of sale. From this point, the process is as described with reference to the LTG card, with the exception that the clerk may hand the installing dealer a computer-generated printout that includes the license key for the system being purchased and all features purchased, or the card itself can be given to the installing dealer such that the dealer can redeem the license key at a later time via the manufacturer's license server Alternatively, the clerk may also execute an e-mail from the manufacturer's license server sending the installing dealer the license key electronically.

Continuing this example, the clerk enters the MAC address of the generic PCB module contained in the standard steel cabinet, the serial number of the card, and the control number of card into the manufacturer's license server, and selects from a listing of available configurations, enhancements, and technology integrations, thereby creating a license key and/or creating the unique licensing associated with the serial number of the CTG card. The installing dealer then enters the license key into the software residing on the PCBA enclosed in the standard steel cabinet, and the software features that are a part of the Elite-36 license are activated. If the installing dealer's customer later decides to upgrade, they can simply visit the reseller/distributor, purchase the appropriate LTG card for the upgrade, obtain the license key as described herein, and then enter the license key into the installed system in the field.

While the use of LTG cards or tokens to upgrade software of existing systems in the field and the use of CTG cards or tokens to configure generic hardware share many similarities, there are also important differences. For instance, while a LTG token represents an upgrade for one specific set of enhancements or feature integrations, the license server can assign a software license key to a CTG token at the point-of-sale that can represent multiple integrations in addition to the base model configuration.

In one implementation, the license key provided by an activated LTG or CTG card is a lengthy string of characters, with each character generally representing a portion of the overall system configuration (i.e., which features are on, and which ones are off). An LTG card can typically only change one of those characters (representing one technology enhancement or group of features). By contrast, against a blank canvas (a generic piece of hardware), the CTG card can determine and assign all characters in the entire license key string. In other words, whereas the LTG card represents one digit in the string of an existing base model license key, the CTG card can generate the initial license key, which includes the base model and the entire set of feature integrations and enhancements available to that base model.

As it may be difficult or unrealistic to apply a license key generated from a CTG card at checkout to the fully packaged control system while at the register, the installing key may alternatively be entered later by the installing dealer. For instance, a key may be printed on a piece of paper at check out, and be ready for immediate entry into the access control system when the access control system is installed on site. Alternatively, the CTG card itself may be assigned to the specific hardware MAC address via the card serial number, so that the installing dealer can go to the license server when ready and enter information to identify himself in order to receive the license key that was generated at check out, and that can only work with that specific system anyway. The license key may be received electronically for ease of entry into the controller. This allows distributors to minimize inventory even further as the configurable CTG card is a generic wild card that can be used to replace upwards of 50 LTG cards. So, a distributor needs only to stock generic hardware and generic CTG cards to configure all possible models and features that the product line can offer.

As described herein, while an Internet connection is typically required in order to redeem an LTG card or to create a license for a specific MAC address, the license key can thereafter be applied to the access control system panel without any Internet connection and typically behind a firewall. In addition to an Internet connection between the license server and distributor, CTG is supported by back-end e-commerce infrastructure that is practiced in the trade and known to those of skill in the art. The Internet connection is used to configure the CTG card and/or to print out the license key. The serial number of the CTG card may also be used as a purchase order/invoice tracking mechanism for accounting purposes. For example, when the card is processed at the register it can represent submission of a purchase order for the integrations or upgrades, and cause an invoice to be instantaneously issued upon delivery of the unique license key for the specific MAC address. However, as with LTG, no Internet connection is necessary to apply the CTG-generated key to the access control system.

The LTG/CTG cards may also be used with the license server for other items beyond the license key configuration, such as registering an extended warranty. For example, an extended warranty may be sold at the distributor's location via the LTG/CTG card or token. When the installing dealer goes to the license server to “redeem” the MAC address, serial number, and control number, rather than issuing a new license key, the licenser server instead registers the date and the MAC address against the serial number on the card, which it recognizes as an extended warranty package, and routes the dealer into a registration screen to capture all necessary registration information to manage the extended warranty. No license key is generated and the warranty is merely added to the database for that specific MAC address. Thus, the license server can also act as a warranty or an extended warranty registration mechanism, thereby providing the convenience of managing everything from one database. A warranty administrator can access the license server when processing a claim to quickly and easily determine whether a specific MAC address is covered under a warranty or not.

In addition, the license server may also facilitate dissemination of any documentation that is needed or necessary with each of the available enhancements and integrations. For example, if a dealer redeems an LTG card for integrated video recording and management capabilities, there may be installation or users manuals or documents that would be helpful when installing or operating a system that includes these capabilities. When applicable and during the license key generating process, an option may be presented to download and/or e-mail applicable manuals associated with the integration that the license key is enabling. This ensures that the dealer receives the most updated manuals as soon as possible (rather than including them in the LTG card packaging and becoming outdated while sitting on the shelf), reduces the cost of the packaging by eliminating a printed manual or manual storage device such as a thumb drive), and keeps the LTG and CTG cards and packaging as small as possible such that shelf space requirements and costs are reduced. In addition, from a legal/liability perspective, active download of a document for a specific MAC address during the license creation process is evidence that a document was actively downloaded.

While the invention has been described with respect to embodiments thereof, it will be apparent to those skilled in the art that the invention may be modified in numerous ways and may assume many embodiments other than those specifically set out and described above. For instance, although the invention has been described primarily with reference to an access control system, it may be applied to many other types of systems capable of being upgraded as described herein. The appended claims cover all modifications that fall within the true spirit and scope of this invention.

1. A method for upgrading a control system comprising:
providing a portable token that contains at least two identifiers, wherein at least one of the identifiers is concealed from view in its packaging;
generating a license key from at least two identifiers and a unique identifier of the control system that is being upgraded; and
allowing access to additional capacities and software features that are resident on the control system upon entry of the license key.

2. The method of claim 1, wherein the portable token is a card that contains a serial number as one identifier and a control number as another identifier.

3. The method of claim 2, wherein the serial number is visible through the packaging and the control number is concealed.

4. The method of claim 3, wherein the control number is covered by a tamper-revealing film that must be scratched off in order to reveal the control number.

5. The method of claim 2, wherein the control number is derived from an algorithm that is indexed off of the serial number.

6. The method of claim 2, wherein the control number can be derived from the serial number by reference to a cross-reference table linking the control number to the serial number, thereby allowing use of either random or algorithmic control numbers and the ability to change control number algorithms as needed to increase security against reverse engineering of the algorithm.

7. The method of claim 1, wherein the unique identifier of the access control system is a MAC address of the access control system.

8. The method of claim 1, wherein the license key is generated by accessing a license server via the Internet.

9. The method of claim 8, wherein the license server generates a custom webpage that displays information about each of a user's systems that has been previously registered or upgraded including MAC addresses of the systems, previously-used license keys, locations of the systems, system types and dates of registration.

10. The method of claim 9, where the license server provides the user with options via the custom webpage including selecting a system to upgrade, adding a license key, editing system information, deleting a system, adding a new system to their profile, and obtaining documentation associated with enhancements and integrations.

11. The method of claim 1, wherein the license key is entered directly into the control system without the need for an Internet connection.

12. The method of claim 1, wherein the control system is an access control system, and the license key allows upgrade of the access control system to a greater door, user and event transaction capacity.

13. The method of claim 1, wherein the control system is an access control system, and the license key allows upgrade of the access control system to include additional features selected from a group consisting of video recording management and monitoring/playback integration, API integration with burglar alarm panels, activation of API communications for third party application development, activation of third party software that co-resides with the access control software in a PCB module (hardware) to allow for multiple software programs to run concurrently and in conjunction with the access control software, activation of asset tracking and management systems, visitor badging and management systems, payroll related time and attendance systems, energy management systems and intercom capabilities.

14. The method of claim 12, wherein the access control system is a member of a family of access control systems that have a common hardware and software platform.

15. A token for obtaining a license key to upgrade a control system, comprising:
a first identifier that is visible on the token; and
a second identifier that is concealed by a temporary cover on the token, wherein
the serial number and the control number allow the license key to be obtained when provided to a third party in conjunction with an identifier of the control system.

16. The token of claim 15, wherein
the token is a plastic card;
the first identifier is a serial number that is visibly provided on the plastic card; and
the second identifier is a control number that is covered by a tamper-revealing film that can be scratched off to reveal the control number.

17. The token of claim 16, wherein the control number can be derived from the serial number by application of an algorithm to the serial number.

18. The token of claim 16, wherein the control number can be derived from the serial number by reference to a cross-reference table linking the control number to the serial number, thereby allowing use of either random or algorithmic control numbers and the ability to change control number algorithms as needed to increase security against reverse engineering o the algorithm.

19. The token of claim 16, wherein the identifier of the control system is a MAC address of the control system.

20. A system for distributing a license key for upgrading an access control system of a product family, comprising:
a portable token that includes first and second identifiers;
an access control system identified by a third identifier;
a license server that generates the license key from the first, second and third identifiers, wherein
the license key is operative to allow access to software features that are resident on the access control system without the need for an Internet connection, and
the license key is operative with any other system in the product family or is operative with only one specific system based on the third identifier.

21. The system of claim 20, wherein
the portable token is a card with a serial number as the first identifier and a control number as the second identifier; and
the third identifier is a MAC address of the access control system.

22. The system of claim 21, wherein the serial number is visible on the card and the control number is concealed.

23. The system of claim 22, wherein the license server can derive the control number from the serial number in order to validate the card.
